(19) United States
(12) Patent Application Publication
(10) Pub. No.: US 2024/0290161 A1
(43) Pub. Date: Aug. 29, 2024

(54) COVER, CASH INLET, AND CASH HANDLING APPARATUS

(71) Applicant: Glory Ltd., Himeji-shi (JP)

(72) Inventors: Takayuki KURODA, Himeji-shi (JP); Koichi NISHIDA, Himeji-shi (JP); Hiroshi DANJO, Himeji-shi (JP); Yoshihiro YODA, Himeji-shi (JP)

(73) Assignee: Glory Ltd., Himeji-shi (JP)

(21) Appl. No.: 18/582,681

(22) Filed: Feb. 21, 2024

(30) Foreign Application Priority Data
Feb. 24, 2023 (JP) 2023-027138

(51) Int. Cl. G07F 1/04

(52) U.S. Cl. CPC G07F 1/045

(57) ABSTRACT

A cover, of a cash inlet of a cash handling apparatus, comprises an upper surface and a base. The upper surface is shaped to have an opening for depositing cash into the cash inlet and to block intrusion of liquid from above into the cash inlet. The base includes a groove to receive the liquid that has been received on the upper surface and which has flowed along the upper surface. The upper surface has a slope upon which the liquid flows in a first direction, and the groove receives the liquid having flowed in the first direction along the slope, and the liquid is discharged in a second direction different from the first direction.

### CROSS-REFERENCE TO RELATED APPLICATION

The present application claims priority to Japanese patent application JP 2023-027138, filed Feb. 24, 2023, the entire contents of which is incorporated herein by reference.

### TECHNICAL FIELD

The present disclosure relates to a cover for preventing liquid from intruding into a cash handling apparatus, a cash inlet provided with the cover, and a cash handling apparatus provided with the cash inlet and the cover.

### BACKGROUND ART

Conventionally, in stores where transactions with customers are performed, cash handling apparatuses are used for settlements of monetary amounts of the transactions. At the time of a settlement, banknotes and coins paid by a customer are deposited in a cash handling apparatus, and change to be returned to the customer is dispensed from the cash handling apparatus. Self-checkout counters and semi-self-checkout counters are increasing in the market. At these counters, cash handling apparatuses into which customers directly deposit cash by themselves are increasingly being used. There is a case where a customer puts by mistake a foreign matter other than cash into a cash inlet of such a cash handling apparatus. For example, if liquid such as coffee or juice is put into the cash handling apparatus from the inlet, cleaning of the inside of the apparatus may be required, or the liquid may cause malfunction of the apparatus.

U.S. Pat. No. 10,453,289 discloses a coin chute that prevents intrusion of liquid. This coin chute causes liquid received from above to flow in one direction. The liquid is discharged from a discharge port provided at a bottom surface of the coin chute. An upper surface of the coin chute is roughly divided into two areas. An opening to lead coins into an apparatus is formed in one area, and a slope is formed in the other area. The slope is formed to decrease in height as the distance from the opening for coins increases, so that the liquid flows in a direction away from the opening of the coin chute which leads to the inside of the apparatus. A portion where the liquid having flowed down the slope accumulates is provided with a discharge port for discharging the liquid from the bottom surface of the coin chute. The opening of the coin chute is covered with a cover to prevent liquid from intruding into the apparatus. This cover also has a slope formed at its upper surface. The liquid received on the cover at one side of the coin chute flows down the slope of the cover toward the other side of the coin chute, flows down the slope of the coin chute, and is discharged from the discharge port.

### SUMMARY

The present disclosure provides a cover of a cash inlet of a cash handling apparatus. The cover comprises an upper surface and a base. The upper surface is shaped to have an opening for depositing cash into the cash inlet and to block intrusion of liquid from above into the cash inlet. The base includes a groove to receive the liquid that has been received on the upper surface and which has flowed along the upper surface. The upper surface has a slope upon which the liquid flows in a first direction, and the groove receives the liquid having flowed in the first direction along the slope, and the liquid is discharged in a second direction different from the first direction.

The objects, features, advantages, and technical and industrial significance of this disclosure will be better understood by the following description and the accompanying drawings of the disclosure.

### BRIEF DESCRIPTION OF THE DRAWINGS

FIG. 1 is an external view showing an example of a cash handling apparatus according to the present disclosure;

FIG. 2 illustrates a method for mounting a banknote-inlet cover and a coin-inlet cover to the cash handling apparatus;

FIGS. 3A and 3B illustrate a configuration of the banknote-inlet cover;

FIGS. 4A and 4B illustrate a configuration of the coin-inlet cover;

FIGS. 5A and 5B show the banknote-inlet cover and the coin-inlet cover, respectively, as viewed from the side;

FIGS. 6A and 6B show a banknote-inlet cover;

FIGS. 7A and 7B show a coin-inlet cover;

FIG. 8 illustrates a method for using the banknote-inlet cover and the coin-inlet cover mounted to the cash handling apparatus;

FIGS. 9A to 9C illustrate another example of a coin-inlet cover;

FIGS. 10A and 10B illustrate an example of a coin-inlet cover including a recessed area; and

FIGS. 11A and 11B illustrate a still another example of a cover for a cash handling apparatus.

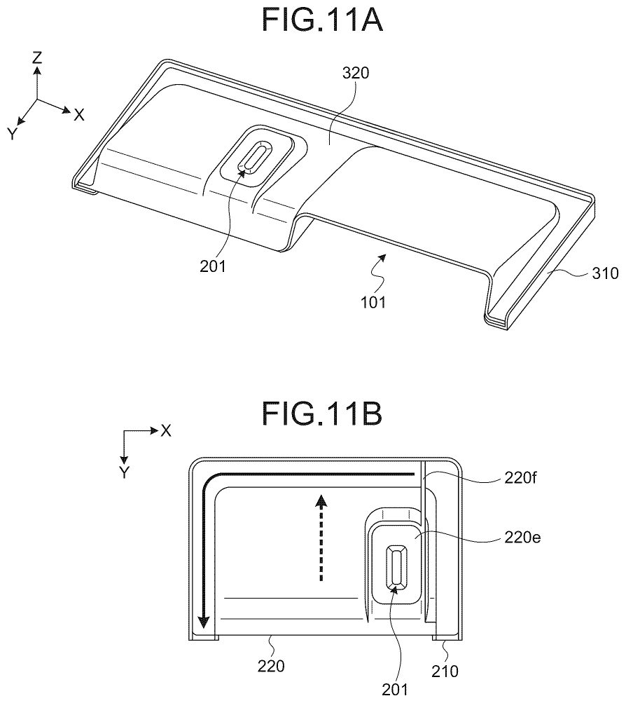

### DETAILED DESCRIPTION

The inventors of the present disclosure have recognized problems with conventional technologies. A conventional apparatus needs a discharge port for discharging liquid from a bottom surface of a coin chute and a component for treating the discharged liquid. In order to apply the coin chute to a conventional apparatus, the apparatus requires modification and/or replacement of parts. Additionally, if discharge performance of the discharge port is not sufficient for the amount of liquid, the sloped portion cannot store all the liquid, and overflowing liquid may intrude into the apparatus through the coin inlet.

The inventors have developed technology as described in the present disclosure to address the above problems as well as other problems with the conventional art. In particular, the inventors have developed technology as described in the present disclosure for a cover which effectively prevents liquid from intruding into a cash handling apparatus, a cash inlet provided with the cover, and a cash handling apparatus provided with the cash inlet and the cover.

Hereinafter, a cover, a cash inlet provided with the cover, and a cash handling apparatus provided with the cash inlet and the cover, according to the present disclosure will be described with reference to the accompanying drawings. One object of the present disclosure is to prevent intrusion of liquid into the cash handling apparatus by providing the cash inlet with the cover. The type of “liquid” is not particularly limited. Examples of the liquid include rain, snow, water, and beverages such as coffee and juice.

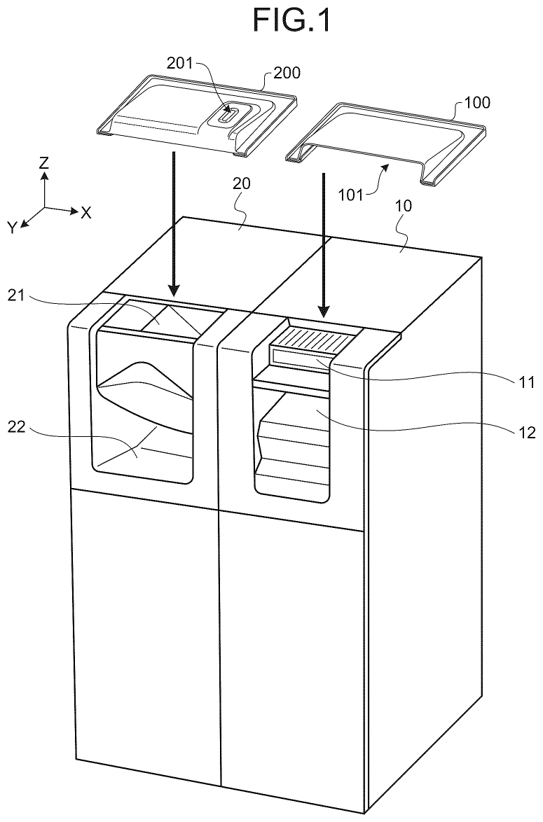

FIG. 1 is an external view showing an example of the cash handling apparatus according to the present disclosure. The cash handling apparatus includes a banknote handling apparatus 10 and a coin handling apparatus 20. The banknote handling apparatus 10 and the coin handling apparatus 20 may not necessarily be separate apparatuses as shown in FIG. 1, and may be integrated with each other to form one apparatus.

The banknote handling apparatus 10 includes a banknote inlet 11 and a banknote outlet 12. The banknote handling apparatus 10 performs a banknote depositing process and a banknote dispensing process. In the depositing process, the banknote handling apparatus 10 takes, into inside of the banknote handling apparatus 10, banknotes received in the banknote inlet 11. The banknote handling apparatus 10 recognizes and counts the banknotes, and outputs the count result to an external device. The deposited banknotes are stored in a storage unit provided inside of the banknote handling apparatus 10. In the dispensing process, based on a dispensing instruction inputted from the external device, the banknote handling apparatus 10 feeds out, from the storage unit in the apparatus, banknotes to be dispensed, and discharges the banknotes from the banknote outlet 12. The banknote handling apparatus 10 may perform only the depositing process, or may perform cash handling processes other than the depositing process and the dispensing process.

The coin handling apparatus 20 includes a coin inlet 21 and a coin outlet 22. The coin handling apparatus 20 performs a coin depositing process and a coin dispensing process. In the depositing process, the coin handling apparatus 20 takes, into inside of the coin handling apparatus 20, coins received in the coin inlet 21. The coin handling apparatus 20 recognizes and counts the coins, and outputs the count result to the external device. The deposited coins are stored in a storage unit provided inside of the coin handling apparatus 20. In the dispensing process, based on a dispensing instruction inputted from the external device, the coin handling apparatus 20 feeds out, from the storage unit in the apparatus, coins to be dispensed, and discharges the coins from the coin outlet 22. The coin handling apparatus 20 may perform only the depositing process, or may perform cash handling processes other than the depositing process and the dispensing process.

The cash handling apparatus can be used for checkout when a transaction with a customer is made in a store, for example. The banknote handling apparatus 10 and the coin handling apparatus 20 can be connected to and used with a terminal such as a cash register. When the monetary amount of the transaction with the customer has been determined by using the cash register, the cash handling apparatus performs the depositing process for cash paid by the customer. In the depositing process, depositing of banknotes, out of the cash paid by the customer, is performed by using the banknote handling apparatus 10 while depositing of coins is performed by using the coin handling apparatus 20. If the total amount of the cash paid by the customer exceeds the monetary amount of the transaction, the cash handling apparatus performs a dispensing process to return change to the customer. In the dispensing process, dispensing of banknotes, out of the change to be returned to the customer, is performed by using the banknote handling apparatus 10 while dispensing of coins is performed by using the coin handling apparatus 20. Since the cash handling apparatus that includes the banknote handling apparatus 10 and the coin handling apparatus 20 and is used in stores has been known, detailed description of the configuration and operation thereof is omitted. How and where to use the cash handling apparatus are not particularly limited. The cash handling apparatus may be installed outside the store, and may be used for purposes other than checkout. The cash handling apparatus may be installed at a place other than stores.

As shown by arrows in FIG. 1, a banknote-inlet cover 100 is mounted to the banknote inlet 11 and a coin-inlet cover 200 is mounted to the coin inlet 21. The banknote-inlet cover 100 has an opening 101 for depositing banknotes. The opening 101 is formed in a side surface (front surface) of the banknote-inlet cover 100 in the example shown in FIG. 1, but the opening 101 may be formed in another surface such as a top surface. After the banknote-inlet cover 100 has been mounted to the banknote inlet 11, banknotes can be deposited in the banknote inlet 11 through the opening 101. The banknote-inlet cover 100 has a shape that covers an upper side of at least the opening, which communicates with the inside of the banknote handling apparatus 10, of the banknote inlet 11. In the example shown in FIG. 1, the banknote-inlet cover 100 has a shape that covers almost the whole of the upper side of the banknote inlet 11. The opening 101 is formed extending over almost the whole of the banknote inlet 11 in the width direction so as not to interfere with a banknote depositing operation. As shown in FIG. 1, the banknote-inlet cover 100 is configured to be mountable from the outside of the banknote handling apparatus 10. Thus, the banknote-inlet cover 100 can be added to and used with a conventional banknote handling apparatus.

The coin-inlet cover 200 has an opening 201 for depositing coins. The opening 201 is formed in a top surface of the coin-inlet cover 200 in the example shown in FIG. 1, but the opening 201 may be formed in another surface such as a side surface. After the coin-inlet cover 200 has been mounted to the coin inlet 21, coins can be deposited in the coin inlet 21 through the opening 201. The coin-inlet cover 200 has a shape that covers an upper side of at least the opening, which communicates with the inside of the coin handling apparatus 20, of the coin inlet 21. In the example shown in FIG. 1, the coin-inlet cover 200 has a shape that covers almost the whole of the upper side of the coin inlet 21. The opening 201 has a size that allows insertion of at least one coin. The opening 201 may have a size that allows insertion of a plurality of coins. For example, two or three coins may be deposited at the same time through the opening 201. As shown in FIG. 1, the coin-inlet cover 200 is configured to be additionally mountable from the outside of the coin handling apparatus 20. Thus, the coin-inlet cover 200 can be added to and used with a conventional coin handling apparatus.

The banknote-inlet cover 100 and the coin-inlet cover 200 are formed of a transparent material that allows the inside of the cover to be visible from the outside. Even after the banknote-inlet cover 100 has been mounted to the apparatus 10, the state in which banknotes are taken into the apparatus 10 from the banknote inlet 11 can be visually confirmed from the outside of the cover 100. Similarly, even after the coin-inlet cover 200 has been mounted to the apparatus 20, the state in which coins are taken into the apparatus 20 from the coin inlet 12 can be visually confirmed from the outside of the cover 200. The banknote-inlet cover 100 and the coin-inlet cover 200 may not necessarily be completely transparent, and may be semi-transparent or colored as long as the banknotes and the coins are visible from the outside. The banknote-inlet cover 100 and the coin-inlet cover 200 are preferably formed of a material such as polycarbonate that is resistant to cracks and scratches. However, the material is not particularly limited, and another material such as acrylic resin may be used.

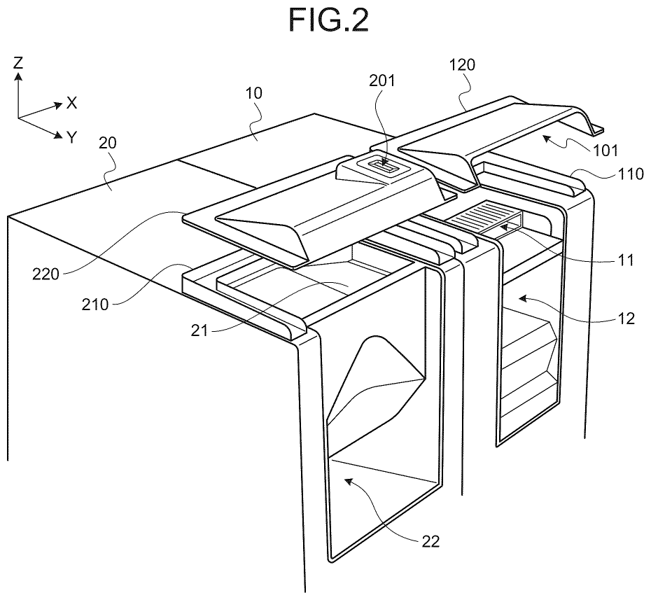

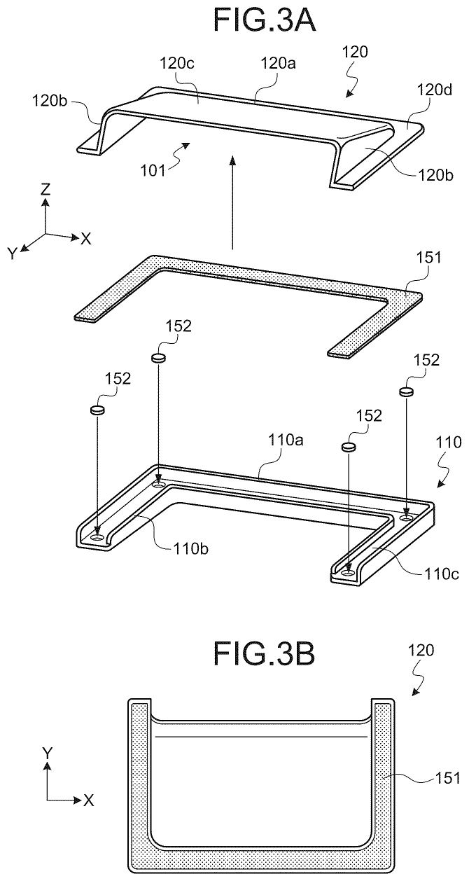

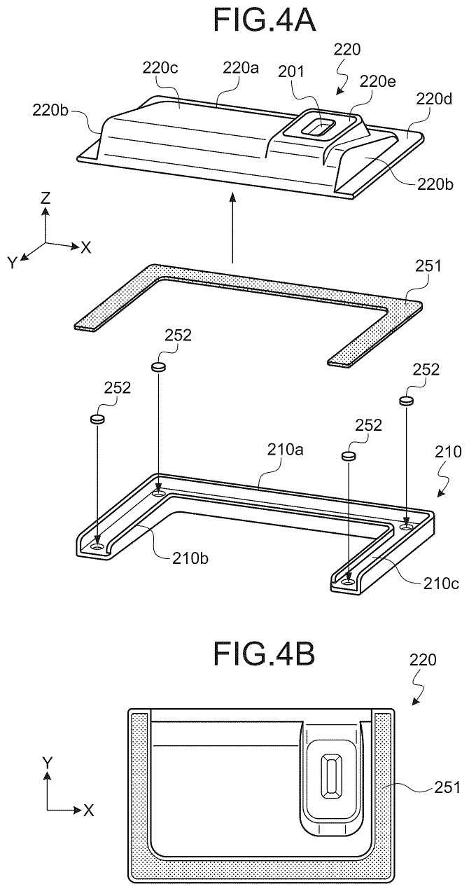

FIG. 2 illustrates a method for mounting the banknote-inlet cover 100 and the coin-inlet cover 200 to the cash handling apparatus. FIGS. 3A and 3B illustrate the configuration of the banknote-inlet cover 100. FIGS. 4A and 4B illustrate the configuration of the coin-inlet cover 200. In each of the figures used in the present disclosure, coordinate axes are shown so that the relationship of the components shown in each figure can be understood. The directions of coordinate axes of X, Y, and Z correspond to the right-left direction (width direction), the front-rear direction, and the up-down direction, respectively, of the cash handling apparatus. The Z-axis positive direction is the upward direction. The front surface of the cash handling apparatus is on the Y-axis positive direction side of the apparatus. The user is present on the front surface side of the cash handling apparatus to use the apparatus. The right side, as viewed from the user using the cash handling apparatus, is the X-axis positive direction. Hereinafter, the banknote-inlet cover 100 will be described first. Therefore, when describing the coin-inlet cover 200 later, details already described for the banknote-inlet cover 100 may be omitted. The details described for the banknote-inlet cover 100 may be applicable to the coin-inlet cover 200 except description on a difference in shape between the upper surfaces of the covers.

The banknote-inlet cover 100 includes a base cover 110 and an upper cover 120. As shown in FIG. 2, the base cover 110 is fixed to the banknote inlet 11 at a predetermined position. The fixing method is not particularly limited. For example, the base cover 110 may be fixed to the banknote handling apparatus 10 via a double-sided tape adhered to the underside surface thereof. An adhesive agent may be used to fix the base cover 110 to the apparatus 10. The base cover 110 has a U shape as viewed from above. The base cover 110 is fixed so as to surround three sides of the banknote inlet 11. Specifically, the base cover 110 is fixed to the upper surface of the banknote handling apparatus 10 such that the U shape thereof surrounds the outer left and right sides and the outer back side of the banknote inlet 11. The base cover 110 has an outer peripheral wall 110a as shown in FIG. 3A. When the base cover 110 is fixed to the apparatus 10 as shown in FIG. 2, the base cover 110 can stop liquid that flows on the upper surface of the banknote handling apparatus 10. Specifically, the base cover 110 is fixed so as to surround the banknote inlet 11 and closely adhere to the upper surface of the banknote handling apparatus 10, thereby preventing intrusion of liquid from the outside of the base cover 110 into the banknote inlet 11 on the upper surface of the banknote handling apparatus 10.

As shown in FIG. 3A, the base cover 110 of the banknote-inlet cover 100 has a groove that allows liquid to flow. The groove has a recessed cross section formed by the outer peripheral wall 110a, an inner peripheral wall 110b, and a bottom surface 110c. The upper side of the groove is opened. In the groove, the height of the bottom surface 110c is largest at the back surface side (Y-axis negative direction side) and is gradually decreased toward the front surface side (Y-axis positive direction side) so that the liquid in the groove flows from the back surface side toward the front surface side. Both ends of the groove, which are on the front surface side when the base cover 110 is fixed to the banknote inlet 11, have no side wall. That is, the both ends of the groove are opened. The both ends serve as discharge ports for discharging the liquid having flowed in the groove.

Blind holes are formed at a plurality of positions in the bottom surface 110c of the groove of the base cover 110, and magnets 152 are inserted and fixed in the respective holes. Each magnet 152 is fixed with its upper surface being flush or roughly flush with the bottom surface 110c of the groove. As shown in FIG. 3B, a sheet metal 151, which is a metal member such as a thin iron plate, is fixed to the underside surface of the upper cover 120. The method for fixing the sheet metal 151 to the upper cover 120 is not particularly limited. A double-sided tape or an adhesive agent may be used to fix the upper cover 120 and the sheet metal 151.

The underside surface of the upper cover 120 is formed in a U shape that fits into inside of the groove of the base cover 110. As shown in FIG. 3B, the sheet metal 151 is fixed to the U-shaped underside surface of the upper cover 120. As shown in FIG. 2, when the underside surface of the upper cover 120 is fitted in the groove of the base cover 110, the upper cover 120 is fixed to the base cover 110 by using the sheet metal 151 fixed to the underside surface of the upper cover 120, and the magnets 152 embedded in the bottom surface 110c of the groove formed in the base cover 110. While the base cover 110 is positioned at a predetermined position and fixed to the banknote inlet 11, the upper cover 120 can be easily dismounted from the base cover 110, i.e., from the banknote inlet 11. Since the underside surface of the upper cover 120 has the U shape corresponding to the U-shaped groove of the base cover 110, the upper cover 120 can be positioned at a predetermined position with respect to the base cover 110 while being mountable and dismountable with respect to the base cover 110. If the number of banknotes to be deposited is large, the banknotes can be deposited from the banknote inlet 11 with the upper cover 120 being removed.

The coin-inlet cover 200 includes a base cover 210 and an upper cover 120, and is fixed to the coin inlet 21 in the same method as that of the banknote-inlet cover 100. The base cover 210 of the coin-inlet cover 200 shown in FIG. 4A has the same configuration as the base cover 110 of the banknote-inlet cover 100 shown in FIG. 3A.

The base cover 210 is fixed to the coin inlet 21 at a predetermined position by using a double sided tape or the like. The base cover 210 having a U shape as viewed from above is fixed so as to surround three sides of the coin inlet 21. The base cover 210 is fixed to the upper surface of the coin handling apparatus 20 such that the U shape thereof surrounds the outer left and right sides and the outer back side of the coin inlet 21. The base cover 210 has an outer peripheral wall 210a as shown in FIG. 4A. When the base cover 210 is fixed to the apparatus 20 as shown in FIG. 2, the base cover 210 can stop liquid that flows on the upper surface of the coin handling apparatus 20. Specifically, the base cover 210 is fixed so as to surround the coin inlet 21 and closely adhere to the upper surface of the coin handling apparatus 20, thereby preventing intrusion of liquid from the outside of the base cover 210 into the coin inlet 21 on the upper surface of the coin handling apparatus 20.

As shown in FIG. 4B, the underside surface of the upper cover 220 is formed in a U shape that fits into inside of the groove of the base cover 210, and a sheet metal 251 is fixed to the underside surface of the upper cover 220. As shown in FIG. 2, when the underside surface of the upper cover 220 is fitted in the groove of the base cover 210 fixed to the coin inlet 21, the upper cover 220 is positioned at a predetermined position with respect to the base cover 210. The upper cover 220 is fixed to be mountable and dismountable with respect to the base cover 210, by the sheet metal 251 on the underside surface of the upper cover 220, and the magnets 252 embedded in the bottom surface 210c of the groove formed in the base cover 210. If the number of coins to be deposited is large, the upper cover 220 may be removed, whereby the coins can be easily inserted in the coin inlet 21 having an opening larger than the opening 201.

The method for fixing the upper cover 120, 220 to the base cover 110, 210 is not particularly limited as long as the upper cover 120, 220 is mountable and dismountable and can be positioned at a predetermined position with respect to the base cover 110, 210. For example, the sheet metal 151, 251 may be fixed to the base cover 110, 210, and the magnets 152, 252 may be fixed to the upper cover 120, 220. Magnets may be fixed to both the base cover 110, 210 and the upper cover 120, 220 with the magnetic poles thereof being adjusted so that the upper cover 120, 220 is mountable and dismountable with respect to the base cover 110, 210. The blind holes for embedding the magnets 152, 252 may be formed in the underside surface of the base cover 110, 210. Magnet sheets may be used instead of the magnets 152, 252 in the grooves. The upper cover 120, 220 may be fitted and fixed to the base cover 110, 210 without using magnets. For example, projections may be formed on one of the base cover 110, 210 and the upper cover 120, 220, and recesses corresponding to the projections may be formed in the other cover, such that the upper cover 120, 220 can be fitted in and fixed to the base cover 110, 210 as described above. The underside surface of the upper cover 120, 220 need not have the U shape as long as the upper cover 120, 220 can be positioned at a predetermined position with respect to the base cover 110, 210. For example, the underside surface of the upper cover 120, 220 shown in FIG. 3B, 4B may be partially cut.

As shown in FIG. 3A, the upper cover 120 of the banknote-inlet cover 100 is almost entirely opened at the front surface side (Y-axis positive direction side), and this opening forms the opening 101 for depositing banknotes when the banknote-inlet cover 100 is mounted to the banknote inlet 11. The upper cover 120 includes: a sloped upper surface part 120c; a U-shaped flat surface part 120d formed on the left, right, and back sides of the upper surface part 120c; and side surface parts 120a, 120b connecting the upper surface part 120c and the flat surface part 120d. The height of the upper surface part 120c is gradually decreased from the side of the opening 101 toward the back surface side (Y-axis negative direction side) so that liquid falling from above flows toward the back surface side. The flat surface part 120d is a U-shaped thin plate, and the sheet metal 151 is fixed to the underside surface thereof, as described above. The left and right side surface parts 120b and the back side surface part 120a are shaped according to the height of the inner peripheral wall 110b of the base cover 110 so that the entire surface of the sheet metal 151 is closely adhered to the bottom surface 110c of the groove formed in the base cover 110.

As shown in FIG. 4A, the upper cover 220 of the coin-inlet cover 200 includes: a sloped upper surface part 220c; a U-shaped flat surface part 220d formed on the left, right, and back sides of the upper surface part 220c; and side surface parts 220a, 220b connecting the upper surface part 120c and the flat surface part 220d. The upper surface part 220c includes an almost horizontal coin insertion surface 220e aligned with the position of the coin inlet 21 of the apparatus 20 when the upper cover 220 is mounted to the coin inlet 21. The opening 201 is formed in the coin insertion surface 220e. The upper surface part 220c is divided into a front surface side and a back surface side with a part around an edge of the opening 201 on the front surface side (Y-axis positive direction side) being a boundary. Both the front surface side and the back surface side of the upper surface part 220c are sloped, respectively. The area of the back surface side slope is larger than the area of the front surface side slope so that liquid falling from above preferably flows toward the back surface side. The height of the back surface side slope, which occupies most of the upper surface part 220c, is gradually decreased toward the back surface side (Y-axis negative direction side) so that most of the liquid falling from above flows toward the back surface side. The flat surface part 220d is a U-shaped thin plate, and the sheet metal 251 is fixed to the underside surface thereof. Like the upper cover 120 for banknotes, the side surface parts 220a, 220b are shaped according to the height of the inner peripheral wall 210b of the base cover 210 so that the entire surface of the sheet metal 251 on the underside surface of the flat surface part 220d is closely adhered to the bottom surface 210c of the groove of the base cover 210.

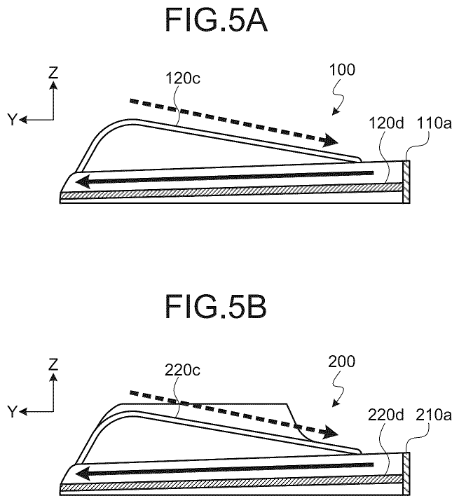

FIGS. 5A and 5B show the banknote-inlet cover 100 and the coin-inlet cover 200, respectively, as viewed from the side (the X-axis positive direction side). In FIG. 5A, a cross section of a part of the outer peripheral wall 110a of the base cover 110 and a cross section of a part of the flat surface part 120d of the upper cover 120 are shown by parallel diagonal lines. When the base cover 110 is fixed to the upper surface of the banknote handling apparatus 10 so as to be aligned with the banknote inlet 11 as shown in FIG. 2 and the upper cover 120 is fixed to the base cover 110, the height of the flat surface part 120d of the upper cover 120 is largest at the back surface side (Y-axis negative direction side) and is gradually decreased toward the front surface side (Y-axis positive direction side). If liquid falls from above, the liquid flows toward the back surface side along the upper surface part 120c of the upper cover 120 and falls into the groove of the base cover 110 as indicated by a broken-line arrow in FIG. 5A. The liquid stopped by the outer peripheral wall 110a of the base cover 110 flows forward on the flat surface part 120d of the upper cover 120 as indicated by a solid-line arrow. That is, the banknote-inlet cover 100 is configured such that the liquid received on the upper surface stars flowing toward the back surface side and then, flows toward the front surface side and discharged from the front surface side along the groove, in order to prevent the liquid received on the upper surface from immediately and directly flowing toward the front surface side of the apparatus 10 where the banknote inlet 11 and the banknote outlet 12 are disposed.

The coin-inlet cover 200 is configured in the same way as that of the banknote-inlet cover 100. When the base cover 210 and the upper cover 120 are fixed to the upper surface of the coin handling apparatus 20, the height of the flat surface part 220d of the upper cover 220 is gradually decreased from the back surface side toward the front surface side as shown by parallel diagonal lines in FIG. 5B. If liquid falls from above, the liquid flows toward the back surface side along the upper surface part 220c of the upper cover 220 and falls into the groove of the base cover 210 as indicated by a broken-line arrow in FIG. 5B. The liquid stopped by the outer peripheral wall 210a of the base cover 210 flows forward on the flat surface part 220d of the upper cover 220. Thus, the coin-inlet cover 200 is also configured such that the liquid received on the upper surface starts flowing toward the back surface side and then, flows toward the front surface side and discharged from front surface side along the groove, in order to prevent the liquid received on the upper surface from immediately and directly flowing toward the front surface side where the coin inlet 21 and the coin outlet 22 are disposed.

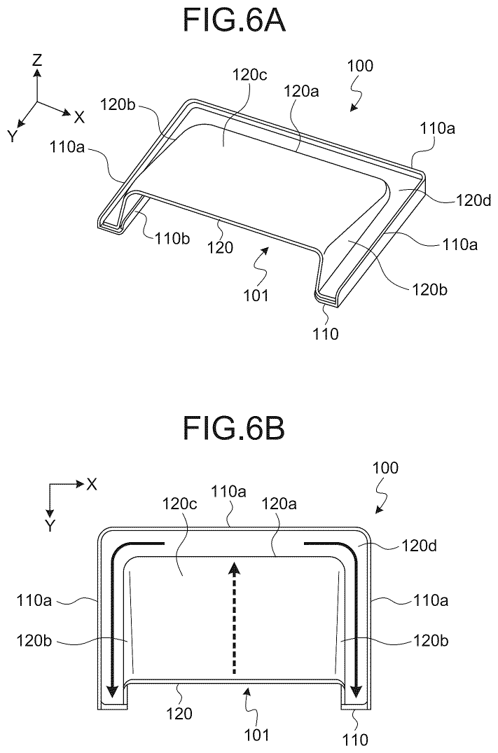

FIGS. 6A and 6B show the banknote-inlet cover 100. As shown in FIG. 6A, when the upper cover 120 is fixed to the base cover 110, a groove is formed between the side surface parts 120a, 120b of the upper cover 120, and the outer peripheral wall 110a of the base cover 110. The upper cover 120 is present on the inner side of the groove, and the outer peripheral wall 110a is present on the outer left, right, and back sides of the groove, while the front surface side of the groove is opened. Therefore, the liquid flows to the back surface side along the sloped upper surface part 120c as indicated by a broken-line arrow in FIG. 6B. The liquid is changed in direction so as to flow along the groove as indicated by solid-line arrows in FIG. 6B. Then, the liquid is discharged to the front surface side (Y-axis positive direction side) as indicated by the solid-line arrows.

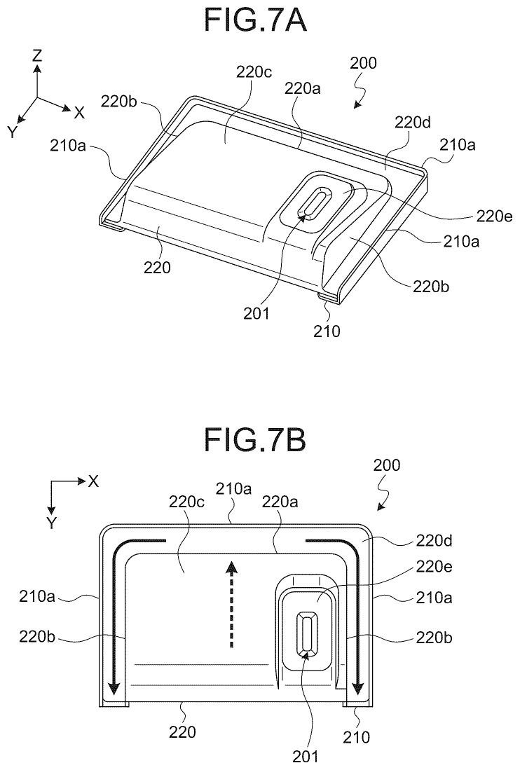

FIGS. 7A and 7B show the coin-inlet cover 200. Like the banknote-inlet cover 100, when the upper cover 220 is fixed to the base cover 210, a groove is formed between the side surface parts 220a, 220b of the upper cover 220, and the outer peripheral wall 210a of the base cover 210 as shown in FIG. 7A. The liquid flows to the back surface side along the sloped upper surface part 220c as indicated by a broken-line arrow in FIG. 7B. The liquid is changed in direction so as to flow along the groove as indicated by solid-line arrows shown in FIG. 7B. Then, the liquid is discharged to the front surface side (Y-axis positive direction side) as indicated by the solid-line arrows.

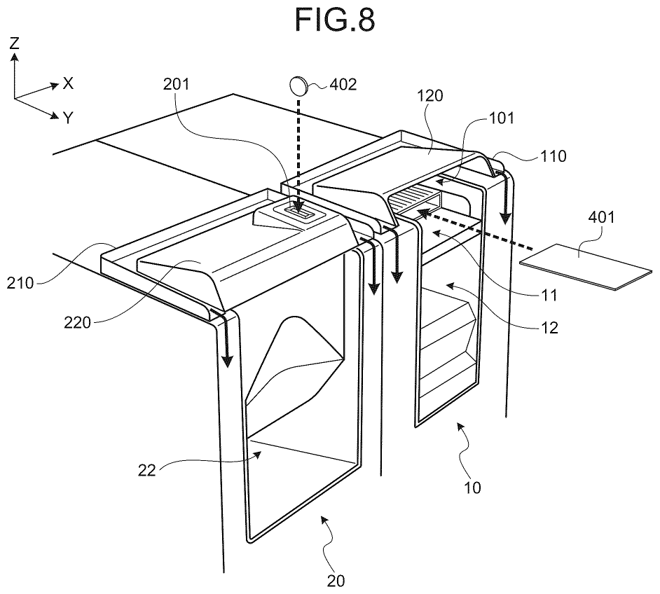

FIG. 8 illustrates a method for using the banknote-inlet cover 100 and the coin-inlet cover 200 in the cash handling apparatus. A banknote 401 is deposited in the banknote inlet 11 from the opening 101, of the upper cover 120, disposed on the front surface side of the banknote handling apparatus 10. A coin 402 is deposited in the coin inlet 21 from the opening 201, of the upper cover 220, disposed on the upper side of the coin handling apparatus 20.

A cash handling apparatus used at a checkout counter in a store may be installed such that at least a part thereof on the back surface side is housed under the counter or a table for placing items. For example, the cash handling apparatus is used such that only the banknote inlet 11 and the coin inlet 21 disposed on the upper surface of the apparatus are exposed from the checkout counter or the item placement table.

A customer at the checkout counter deposits banknotes and coins while looking down the banknote inlet 11 and the coin inlet 21. If the customer spills liquid by mistake while depositing banknotes and/or coins, the banknote-inlet cover 100 and the coin-inlet cover 200 prevent the liquid falling from above from directly intruding into the banknote inlet 11 and the coin inlet 21. Since the liquid falling onto the cover flows to the back surface side along the upper surface of the cover 100, 200 as described above, it is possible to prevent the liquid from immediately and directly flowing to the front surface side and intruding into the banknote inlet 11, the banknote outlet 12, or the coin outlet 22 disposed on the front surface side. The liquid that has started flowing and temporarily flowed to the back surface side along the upper surface of the cover 100, 200, flows along the groove formed in the cover 100, 200 as described above, and is discharged to the apparatus front surface side as shown by arrows in FIG. 8. Even in the case where the cash handling apparatus is installed with the back surface side being housed under the checkout counter or the item placement table, since the liquid is discharged to the front surface side, the liquid is prevented from flowing to the back surface side where cleaning is difficult.

In order to prevent the liquid having flowed through the groove of the banknote-inlet cover 100 from intruding into the apparatus through the banknote outlet 12 disposed below the banknote inlet 11, the liquid is discharged from the opposite outer sides, in the width direction, of the banknote inlet 11 to the apparatus front surface side. Likewise, in order to prevent the liquid having flowed through the groove of the coin-inlet cover 200 from flowing into the coin outlet 22 disposed below the coin inlet 21, the liquid is discharged from the opposite outer sides, in the width direction, of the coin inlet 21 to the apparatus front surface side. The liquid is discharged, toward the front surface side of the apparatus 10, 20, from the both opened-ends of the grooves formed at the both outer sides in the width direction (X-axis direction) of the inlet 11, 21. This avoids a situation that the greater part of the liquid intrudes into the cash handling apparatus and thereby extensive cleaning is required or the apparatus malfunctions.

In the cash handling apparatus, resin-made parts including decorative laminates are often used on the front surface side that the customers use. Meanwhile, since the back surface side of the apparatus is housed under the checkout counter or the item placement table and therefore is hidden from customers, a steel housing on the back surface side may be exposed as it is or holes formed in the housing may be exposed on the back surface side. Even in such cases, the cover configuration that discharges liquid to the front surface side of the apparatus prevents the steel housing of the back surface side from getting dirty and rusting, and prevents the liquid from intruding through the holes of the housing. Thus, damage due to the liquid can be minimized.

The banknote-inlet cover 100 and the coin-inlet cover 200 may be formed of a transparent material. However, the base covers 110, 210 may be formed of an opaque material while the upper covers 120, 220 are formed of a transparent material. Depending on the method for using the cash handling apparatus, even the upper covers 120, 220 may be formed of an opaque material. The material is not limited to resin, and may be other plastics, hard rubber or metal.

The cash handling apparatus includes the banknote handling apparatus 10 and the coin handling apparatus 20. However, the cash handling apparatus may include only the banknote handling apparatus 10, or only the coin handling apparatus 20. Although both the banknote inlet 11 and the coin inlet 21 are provided with the covers in the present disclosure, only one of the banknote inlet 11 and the coin inlet 21 may be provided with the cover. The banknote inlet 11 may also serve as the banknote outlet 12. The cash handling apparatus has the banknote outlet 12 on the upper surface, and cover 100 may be used for the banknote outlet 12 in the same way as described above.

The banknote-inlet cover 100 and the coin-inlet cover 200 may be produced in sizes conforming to the banknote inlet 11 and the coin inlet 21, respectively. For example, the groove shown in FIG. 6 and FIG. 7 which allows liquid to flow has a width of about 10 mm and a height (depth of the groove) of about 3 to 5 mm. The height of the upper cover 120, 220 from the underside surface to the top is about 40 mm. The upper surface part 120c, 220c forms a slope having a drop of 30 mm or more toward the upper edge of the side surface part 120a, 220a on the back surface side. However, these numerical values are merely examples, and do not particularly limit the dimensions of the respective components. For example, the depth of the groove may be 10 mm or more.

In the present disclosure, the liquid that start flowing toward the apparatus back surface side along the upper surface part 120c, 220c of the upper cover 120, 220, is discharged from the apparatus front surface side through the groove of the base cover 110, 210. However, the liquid flowing direction is not limited thereto. The upper surface part 120c, 220c may be formed so as to include a plurality of slopes. The upper surface part 120c, 220c only needs to be sloped so as to cause the liquid to flow toward any side surface, out of the four peripheral side surfaces of the apparatus, other than the front surface because the inlet 11, 21 is disposed on the front side-surface side out of the four peripheral side surfaces. For example, the upper surface part 120c, 220c may be sloped so as to cause the liquid to flow in at least one of the leftward direction, the rightward direction, and the backward direction. The groove of the base cover 110, 210 may be formed so as to discharge the liquid in at least one of the leftward direction, the rightward direction, and the backward direction. The flow direction and the discharge direction of the liquid received on the upper surface part 120c, 220c may be determined according to the installation place and the method for using the cash handling apparatus, and the banknote-inlet cover 100 and the coin-inlet cover 200 may be shaped according to the determined directions. The slope direction of the upper surface part 120c, 220c, the slope direction of the groove of the base cover 110, 210, and the position of the discharge port of the groove shown in FIG. 3 and FIG. 4 may be adjusted according to the determined directions. Discharge of liquid from the base cover 110, 210 may not necessarily be performed from two discharge ports, and may be performed from one discharge port or three or more discharge ports.

In the present disclosure, the base covers 110, 210 have the grooves formed therein. Instead of or in addition to the grooves of the base covers 110, 210, grooves may also be formed in the upper covers 120, 220. The banknote-inlet cover 100 may have a shape in which the base cover 110 and the upper cover 120 are integrated. The coin-inlet cover 200 may have a shape in which the base cover 210 and the upper cover 220 are integrated. That is, the cover 100, 200 may be one body including the groove formed in the same way as that shown in FIG. 6 and FIG. 7. For example, the covers having the shapes shown in FIG. 6 and FIG. 7 may be dismountably mounted to the cash handling apparatus and used, respectively. Specifically, the covers having the shapes shown in FIG. 6 and FIG. 7 may be formed through integral molding, respectively, and the magnets 152, 252 may be fitted and fixed in the holes formed in the underside surfaces of the covers, and the covers may be dismountably mounted by using the sheet metals 151, 251 adhered to the inlets 11, 21 of the cash handling apparatus.

In the present disclosure, the banknote-inlet cover 100 and the coin-inlet cover 200 have different shapes. However, these covers may have the same shape. For example, in the example shown in FIG. 2, the base cover 110 of the banknote-inlet cover 100 and the base cover 210 of the coin-inlet cover 200 may be identical components. The base cover 110 for banknotes being identical to the base cover 210 for coins allows the upper cover 120 for banknotes to be mounted to the base cover 210 for coins and used. Two upper covers 120 for banknotes may be prepared so that the covers of the same shape are used for the coin inlet 21 and the banknote inlet 11. Even when the banknote-inlet cover 100 is mounted to the coin inlet 21, coins can be deposited from the opening 101 into the coin inlet 21. The base covers 110, 210 may be shareable between the banknote-inlet cover 100 and the coin-inlet cover 200. In this case, for example, while the upper cover 220 for coins that is stained with liquid is dismounted for cleaning, the upper cover 120 for banknotes dismounted from the banknote inlet 11 can be mounted to the coin inlet 21 to be used as the coin-inlet cover 200. If an auxiliary upper cover 120 is prepared in advance, even when both the banknote-inlet cover 100 and the coin-inlet cover 200 are stained with liquid, the auxiliary upper cover 120 can be used instead of the stained upper cover 120 while cleaning the stained upper cover 120 and then, the auxiliary upper cover 120 can be used instead of the stained upper cover 220 while cleaning the stained upper cover 220.

The banknote-inlet cover 100 and the coin-inlet cover 200 according to the present disclosure are merely examples, and the shapes of the covers are not limited thereto. Specifically, the shapes of the banknote-inlet cover 100 and the coin-inlet cover 200 may be partially changed according to the shapes of the banknote inlet 11 and the coin inlet 21.

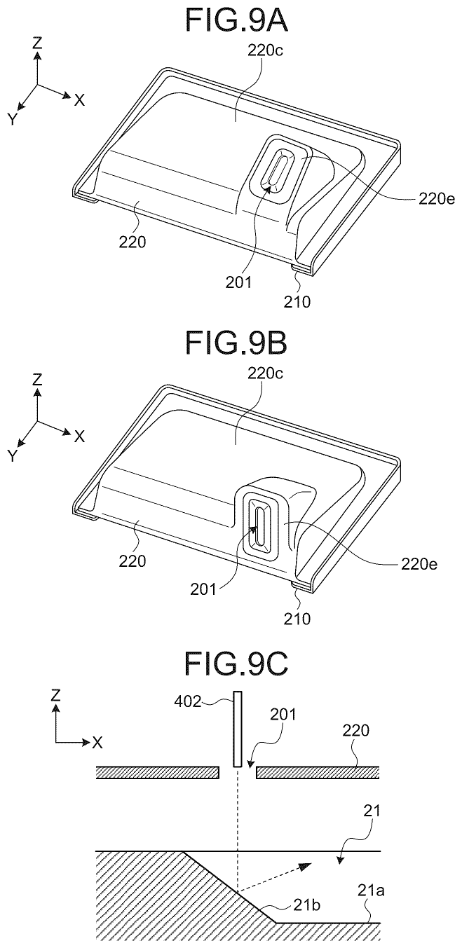

In FIG. 7A, the coin insertion surface 220e having the opening 201 formed therein is an almost horizontal surface parallel to the upper surface of the coin handling apparatus 20. However, as shown in FIG. 9A, the coin insertion surface 220e may be sloped down toward the apparatus front surface side (Y-axis positive direction side). As shown in FIG. 9B, the coin insertion surface 220e may be an almost vertical surface. Although a part of the upper cover 220 for coins on the apparatus front surface side has a slope in the above disclosure, the front side part may be a vertical surface or an almost vertical surface, and the upper surface part 220c may have a shape such that the entirety thereof slopes toward the left, right, or the back surface side with an upper edge of the almost vertical surface being a start point. The upper surface part 220c may include a slope toward only one direction other than front surface side.

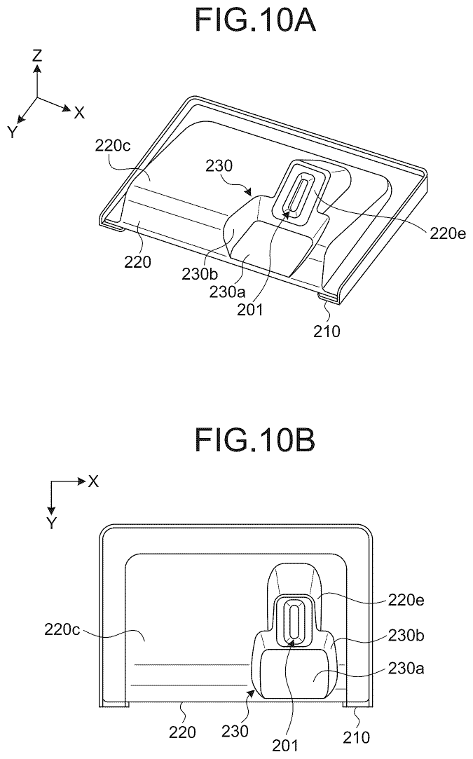

The upper cover 220 of the coin-inlet cover 200 may include a recessed area 230. For example, the recessed area 230 is formed by a bottom surface part 230a and a side surface part 230b as shown in FIG. 10A. FIG. 10B shows the recessed area 230 viewed from above. The recessed area 230 is formed in front of the opening 201 for coin insertion. The side surface part 230b connects the upper surface part 220c of the upper cover 220 and the bottom surface part 230a that is located at a lower position than the top of the upper surface part 220c. The bottom surface part 230a may have a planar shape that becomes a substantially horizontal surface when the coin-inlet cover 200 is mounted to the coin inlet 21. The lower end of the opening 201 may be located at a lower position than the upper surface part 220c. The width of the recessed area 230 in the left-right direction, i.e., the dimension between left and right surfaces of the side surface part 230b, may be wider than the width of the upper part of the coin insertion surface 220e. The side surface part 230b consists of a back-side surface, which is a part of the coin insertion surface 220e, a left-side surface and a right-side surface. That is, the front side of the recessed are 230 is open. A space, which is above the bottom surface part 230a, on the front side of the coin insertion surface 220e including the opening 201 is open by forming the recessed area 230. As a result, it is easy to insert a coin through the opening 201 of the coin insertion surface 220e, so that a hand and/or finger may not hit the upper cover 220.

The position of the opening 201 for coin insertion is merely an example, and the opening 201 may be formed according to the shape of the coin inlet 21. For example, when there are an almost horizontal surface (bottom surface) 21a which forms the coin inlet 21 and feeds coins into the apparatus and a sloped surface (side surface) 21b as shown in FIG. 9C, the opening 201 may be formed above the almost horizontal surface 21a. The opening 201 may be formed above the sloped surface 21b as long as the coin 402 can be led into the coin inlet 21 as indicated by a broken-line arrow in FIG. 9C.

As shown in FIG. 10A, a base cover 310 and an upper cover 320 corresponding to both the banknote inlet 11 and the coin inlet 21 may be used. For example, in a case where the banknote inlet 11 and the coin inlet 21 are located close to each other, the upper cover 320 having a shape in which the upper cover 120 for banknotes is integrated with the upper cover 220 for coins, may be used. The base cover 310 may have a shape obtained by extending the base covers 110, 210 in the horizontal direction (X-axis direction) so as to correspond to the upper cover 320.

In the above disclosure, the liquid having flowed through the groove formed in the banknote-inlet cover 100 or the coin-inlet cover 200 is discharged from the outer left and right sides toward the apparatus front surface side as shown by arrows in FIG. 6B, FIG. 7B and FIG. 8. However, the liquid may be discharged from one of the left and right sides toward the apparatus front surface side. For example, as shown in FIG. 10B, a partition 220f may be added to the upper cover 220 for coins shown in FIG. 7B so that the liquid is discharged from one side. The banknote-inlet cover 100 may also be modified so that the liquid is discharged from one side.

A cover according to the present disclosure includes: an upper surface part configured to prevent intrusion of liquid from above into the cash inlet; and a groove configured to receive the liquid that has been received on the upper surface part and has flowed along the upper surface part. The upper surface part has a slope that causes the liquid received from above to flow in a first direction. The groove receives the liquid having flowed in the first direction along the slope. The groove causes the liquid to flow and to be discharged in a second direction different from the first direction

In the above configuration, the slope of the upper surface part may be inclined so that the liquid flows in a direction toward a first side surface out of four peripheral side surfaces of the cash handling apparatus. The cash inlet is being provided on a direction corresponding to a second side surface, which is different from the first side surface, out of the four peripheral side surfaces.

In the above configuration, the slope of the upper surface part may be inclined so that the liquid flows in a direction toward a first side surface out of the four peripheral side surfaces of the cash handling apparatus. A cash outlet, from which the cash handling apparatus dispenses cash, is being provided on a direction corresponding to a second side surface, which is different from the first side surface, out of the four peripheral side surfaces.

In the above configuration, the groove may cause the liquid to flow and to be discharged in a direction toward one side surface out of four peripheral side surfaces of the cash handling apparatus. The cash inlet is being provided on the direction corresponding to the one side surface.

In the above configuration, the groove may discharge the liquid from a plurality of positions.

In the above configuration, the cover may include: a base cover that includes the groove and is fixed to the cash handling apparatus; and an upper cover that includes the upper surface part and is mountable and dismountable with respect to the base cover.

In the above configuration, the groove of the base cover may be formed in a U shape that surrounds the cash inlet from three sides.

In the above configuration, the groove of the base cover may be formed so as to surround the cash inlet from three sides, and discharge the liquid from remaining one side.

In the above configuration, the groove of the base cover may cause the liquid to flow in a direction toward one side surface out of four peripheral side surfaces of the cash handling apparatus. The cash inlet is being provided on the direction corresponding to the one side surface. The groove discharges the liquid from a position on outside, in a width direction of the side surface, of the cash inlet.

In the above configuration, the base cover may discharge the liquid from two positions on both outsides in the width direction of the cash inlet.

In the above configuration, the upper cover may include a flat surface part formed corresponding to the groove of the base cover, and the flat surface part of the upper cover may be fitted in the groove of the base cover to dismountably fix the upper cover to the base cover.

In the above configuration, the upper cover may be dismountably fixed to the base cover by using a magnet fixed to one of the base cover and the upper cover, and a metal member fixed to the other cover.

In the above configuration, the upper cover may be formed of a transparent material that allows the cash inlet to be visible from the outside of the cover.

A cash inlet according to the present disclosure is provided in a cash handling apparatus. The cash inlet receives cash from the outside of the cash handling apparatus and feeds the cash into the cash handling apparatus. The cash inlet is provided with the cover according to the above configuration.

A cash handling apparatus according to the present disclosure handles cash received from the outside of the cash handling apparatus. The cash handling apparatus includes: a cash inlet configured to receive cash from the outside of the cash handling apparatus, and feed the cash into the cash handling apparatus; and the cover, of the cash inlet, according to the above configuration.

As described above, in the cash handling apparatus, the cash inlet is provided with the cover for preventing intrusion of liquid into inside of the apparatus. The cover is easily mountable and dismountable. Therefore, the cover can be dismounted for cleaning when it gets dirty. When depositing a large quantity of cash, the cash can be deposited after removing the cover from the cash inlet. In order to prevent liquid from falling from the front surface side of the cover toward the cash inlet and/or the cash outlet located below the inlet, the upper surface of the cover has a shape sloping toward the apparatus back surface side. The liquid having flowed to the apparatus back surface side along the upper surface of the cover, flows through the groove formed in the cover, and the liquid is discharged to the apparatus front surface side. The liquid is discharged from the both outer ends of the inlet to avoid intrusion of the liquid into the inlet and the outlet. The cover having the above configuration avoids a situation in which the greater part of the liquid falling onto the cash handling apparatus directly intrudes into inside of the apparatus and thereby extensive cleaning is required or the apparatus malfunctions.

What is claimed is:

1. A cover of a cash inlet of a cash handling apparatus, the cover comprising:
an upper surface shaped to have an opening for depositing cash into the cash inlet and to block intrusion of liquid from above into the cash inlet; and
a base including a groove to receive the liquid that has been received on the upper surface and which has flowed along the upper surface, wherein
the upper surface has a slope upon which the liquid flows in a first direction, and
the groove receives the liquid having flowed in the first direction along the slope, and the liquid is discharged in a second direction different from the first direction.

2. The cover according to claim 1, wherein
the slope of the upper surface is inclined so that the liquid flows in a direction toward a first side surface out of four peripheral side surfaces of the cash handling apparatus, and
the cash inlet is provided on a direction corresponding to a second side surface, which is different from the first side surface, out of the four peripheral side surfaces.

3. The cover according to claim 1, wherein
the slope of the upper surface is inclined so that the liquid flows in a direction toward a first side surface out of four peripheral side surfaces of the cash handling apparatus, and
a cash outlet, from which the cash handling apparatus dispenses cash, is provided on a direction corresponding to a second side surface, which is different from the first side surface, out of the four peripheral side surfaces.

4. The cover according to claim 1, wherein the liquid flows via the groove to be discharged in a direction toward one side surface out of four peripheral side surfaces of the cash handling apparatus, the cash inlet being provided on the direction corresponding to the one side surfaced.

5. The cover according to claim 4, wherein the groove discharges the liquid from a plurality of positions.

6. The cover according to claim 1, wherein the
the base is fixed to the cash handling apparatus, and
the cover further comprises an upper cover which includes the upper surface and is mountable and dismountable with respect to the base.

7. The cover according to claim 6, wherein the groove of the base is formed in a U shape that surrounds the cash inlet from three sides.

8. The cover according to claim 6, wherein the groove of the base surrounds the cash inlet from three sides, and discharges the liquid from a remaining fourth side.

9. The cover according to claim 6, wherein
the liquid flows via the groove in a direction toward one side surface out of four peripheral side surfaces of the cash handling apparatus,
the cash inlet is provided on the direction corresponding to the one side surface, and
the groove discharges the liquid from a position on an outside, in a width direction of the side surface, of the cash inlet.

10. The cover according to claim 9, wherein the base discharges the liquid from two positions which are outside, in the width direction, of the cash inlet.

11. The cover according to claim 6, wherein
the upper cover includes a flat surface formed corresponding to the groove of the base, and
the flat surface of the upper cover is fitted in the groove of the base to dismountably fix the upper cover to the base.

12. The cover according to claim 6, wherein the upper cover is dismountably fixed to the base with a magnet fixed to one of the base and the upper cover, and a metal member fixed to an other of the base and the upper cover.

13. The cover according to claim 6, wherein the upper cover is formed of a transparent material allowing the cash inlet to be visible from an outside of the cover.

14. A cash inlet that is provided in the cash handling apparatus, the cash inlet receives cash from an outside of the cash handling apparatus and feeds the cash into the cash handling apparatus, the cash inlet being provided with the cover according to claim 1.

15. A cash handling apparatus that handles cash received from an outside of the cash handling apparatus, the cash handling apparatus comprising:
a cash inlet configured to receive cash from the outside of the cash handling apparatus, and feed the cash into the cash handling apparatus; and
the cover according to claim 1.
